(19) United States
(12) Patent Application Publication
(10) Pub. No.: US 2017/0212938 A1
(43) Pub. Date: Jul. 27, 2017

(54) METHOD AND APPARATUS FOR ACCESSING AND CALCULATING INDUSTRIAL INFORMATION

(71) Applicant: General Electric Company, Schenectady, NY (US)

(72) Inventors: Mina Botros, Foxborough, MA (US); Stephan James King, Foxborough, MA (US); Jie Lu, Foxborough, MA (US); Gregory Meltzer, Foxborough, MA (US)

(21) Appl. No.: 15/006,186

(22) Filed: Jan. 26, 2016

(51) Int. Cl. G06F 17/30

(52) U.S. Cl. CPC G06F 17/30551; G06F 17/30536

(57) ABSTRACT

Approaches are provided for an apparatus that includes a memory configured to store a plurality of time-series data records. Each time-series data record has a data value having an associated time and corresponding to one or more characteristics of an industrial machine or system. A query corresponding to the one or more characteristics of the industrial machine or system is received at an input. The query includes a query time range and one or two extended interval ranges abutting the query time range. A processor obtains from the memory a first value of a first record having an associated time within the query time range. The processor obtains from the memory device a second value of a second record having an associated time within the extended interval range. The processor calculates a third value having an associated time within the query time range.

### BACKGROUND OF THE INVENTION

Field of the Invention

The subject matter disclosed herein generally relates to accessing information from a database in response to a query. More specifically, the subject matter relates to accessing industrial data corresponding to a query time range. The subject matter further relates to calculating data within a query time range using data obtained outside of the query data range.

Brief Description of the Related Art

In industrial operations, industrial equipment and processes are monitored to ensure proper operation and/or detect anomalies which may arise. Data related to the industrial equipment and processes is collected over time. This data may be stored in a database for later retrieval. Personnel at an operating site and/or at a remote monitoring location may use the information stored in the database to observe historical data and trends in industrial operations.

The volume of data collected over time across multiple systems is typically massive, often on the order of terabytes or petabytes. Such magnitudes of information sometimes render the underlying data unusable in its raw form. Even when the information is usable, personnel may not have access to all relevant information. Database software often compresses the files in which the data is stored, sometimes resulting in lost data points. Furthermore, because the data is typically obtained over scheduled intervals, a user may attempt to access data from a given time during which no data was obtained from an industrial machine.

The above-mentioned problems have resulted in some user dissatisfaction with previous approaches, inefficient industrial machine monitoring, and sub-optimal analysis of industrial machine data.

### BRIEF DESCRIPTION OF THE INVENTION

The approaches described herein provide for accessing existing data relating to industrial machines and equipment. These approaches permit a user to access a database such as a data historian and observe time-series data points having time-stamps within a requested time period. The approaches further provide for calculating previously non-existent data points for time periods within the requested time period, and more specifically, at the beginning and end times of the requested time period.

In many of these embodiments, an apparatus includes a memory configured to store a plurality of time-series data records. Each time-series data record has a data value having an associated time and corresponding to one or more characteristics of an industrial machine or system. A query corresponding to the one or more characteristics of the industrial machine or system is received at an input. The query includes a query time range and one or two extended interval ranges abutting the query time range at either or both ends respectively. The extended interval range may be defined by an extended interval value and at least one of the beginning time and the end time.

A processor obtains from the memory a first value of a first record having an associated time within the query time range. The processor obtains from the memory device a second value of a second record having an associated time within the extended interval range. In some aspects, the time associated with the second value of the second record is earlier in time than the beginning time of the query time range. In other aspects, the time associated with the second value of the second record is later in time than the end time of the query time range.

The processor calculates, based on at least the first value and the second value, a third value having an associated time within the query time range.

In some approaches, the processor is further configured to provide, via an output, a query response comprising at least the first value and the third value.

In some aspects, the processor is further configured to obtain from the memory a fourth value of a fourth record having an associated time within the query time range in response to receiving the query. The processor may further be configured to obtain from the memory a fifth value of a fifth record having an associated time within a second extended interval range in response to receiving the query. Based on at least the fourth value and the fifth value, the processor calculates a sixth value having an associated time within the query time range. The processor may further be configured to provide a query response comprising at least the first value, the third value, the fourth value, and the sixth value.

In another aspect, a method includes storing a plurality of time-series data records in a memory device. Each of the time-series data records has a data value corresponding to one or more characteristics of an industrial machine or system. Each data value also has an associated time.

The method also includes receiving a query corresponding to the one or more characteristics of the industrial machine or system. The query includes a query time range comprising a beginning time and an end time. The query further includes one or two extended interval ranges abutting the query time range at either or both ends respectively.

The method also includes, in response to receiving the query, obtaining from the memory device a first value of a first record having an associated time within the query time range. The method also includes, in response to receiving the query, obtaining from the memory device a second value of a second record having an associated time within the extended interval range.

The method also includes calculating, based on at least the first value and the second value, a third value having an associated time within the query time range.

In some approaches, the method includes providing a query response comprising at least the first value and the third value.

The method may further include, in response to receiving the query, obtaining from the memory device a fourth value of a fourth record having an associated time within the query time range. Also in response to receiving the query, the method may include obtaining from the memory device a fifth value of a fifth record having an associated time within a second extended interval range. Based on at least the fourth value and the fifth value, a sixth value having an associated time within the query time range is calculated.

In some aspects, the method further includes providing a query response comprising at least the first value, the third value, the fourth value, and the sixth value.

### BRIEF DESCRIPTION OF THE DRAWINGS

For a more complete understanding of the disclosure, reference should be made to the following detailed description and accompanying drawings wherein:

FIG. 1 comprises an illustration of an informational flow chart for providing information relating to industrial machines and systems according to various embodiments of the present invention;

FIG. 2 comprises a block diagram illustrating an exemplary apparatus for accessing information relating to industrial machines and systems according to various embodiments of the present invention;

FIG. 3 comprises a schematic diagram illustrating an exemplary approach for accessing information according to various embodiments of the present invention; and

FIG. 4 comprises an operational flow chart illustrating an approach for accessing information according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

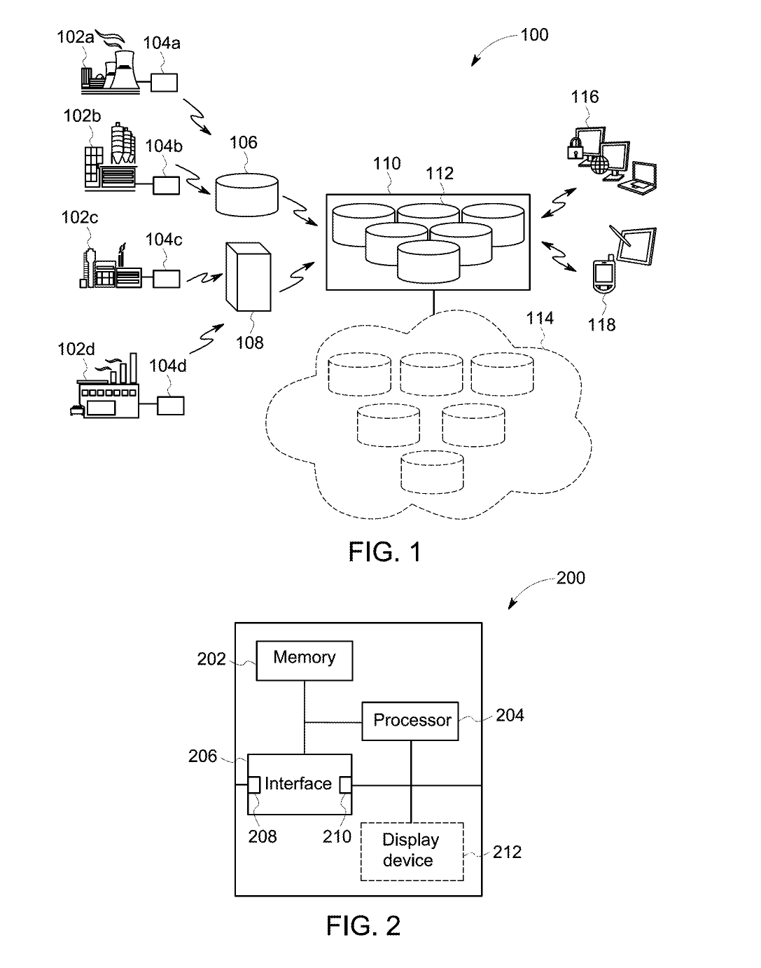

Referring now to FIG. 1, a system 100 for collecting and providing data associated with industrial machines and systems 102a, 102b, 102c, 102d is provided. The industrial machines and systems may be, for example, industrial equipment or processes used in manufacturing facilities (e.g., automotive manufacturing facilities), mining and metals operations, oil and gas operations, pharmaceuticals and life sciences facilities, power and energy operations, and water and wastewater treatment operations.

In such operations and facilities, data related to industrial machines and systems is collected over time, for example, at sensors 104a, 104b, 104c, and 104d. The sensors 104a, 104b, 104c, and 104d collect the data in the form of data values. The sensors may be hard-wired to the associated industrial machine or system, or may be wireless passive sensors.

In some approaches, the industrial data sensed by the sensors 104a, 104b, 104c, and 104d includes process-related characteristics such as flow rate, valve position, vessel level, temperature, vibration, pressure, and speed. Other characteristics are possible. In other approaches, the industrial data includes production or performance information, such as an operational condition of a machine, start/end times, alarms, events, material consumption quantity, units/hour, consumption rates, efficiency, machine utilization vs. machine capacity, scheduled vs. unscheduled outages, and product tracking. Other characteristics are possible. In other approaches, the industrial data includes quality control metrics, such as quality readings inline or offline. In still other approaches, the industrial data includes cost information such as manufacturing costs. Other examples are possible.

The data values may be obtained by automatically reading sensors (e.g. sensors 104a, 104b, 104c, and 104d) and/or by receiving manual input. For example, “online” sensors capture data related to the industrial machines and systems.

The data values may be, for example, in the form of integers, real numbers, bits (e.g., “on” or “off”), text strings (e.g., product name), or a selected item from a list of values (e.g., “low,” “medium,” or “high”). In some operations, the data values are obtained over regular time intervals (e.g., seconds, minutes, hours, days, weeks, months, years). Other time intervals are possible. In other approaches, the data values are obtained at disparate time frequencies. In these approaches, the time that the industrial data was obtained from the industrial machine or system is associated with the data values to provide time-series data.

The collected time-series data may be used to monitor the industrial machines and systems 102a, 102b, 102c, 102d to ensure proper operation and/or to detect anomalies that may arise. Trends associated with the industrial machines and systems 102a, 102b, 102c, 102d may also be observed.

The time-series data may optionally be transmitted to an intermediary data system. For example, the time-series data may be transmitted to an industrial control system 106, such as a distributed control system (“DCS”) or supervisory control and data acquisition (“SCADA”) system. In another example, the time-series data is transmitted to a data processor 108 where the time-series data may be further processed.

The time-series data is then transmitted to a data center 110. The transmission from industrial machines and systems 102a, 102b, 102c, 102d, the industrial control system 106, or the data processor 108 to the data center 110 may be via a wired or wireless transmitter.

The time-series data is stored in database operatively connected to the data center 110. The data center 110 includes a database 112 that may be, for example, a “data historian” or “operational historian” database. The database 112 may be a single database, or may include a plurality of databases that make up a distributed computing network. The database 112 stores the time-series data associated with industrial machines or systems (e.g., industrial machines or systems 102a, 102b, 102c, 102d). Software applications may be used to log or historize the data, or to compress the data. The data center 110 preferably utilizes a mapping paradigm.

In one approach, the database is a local database 112 located geographically at the data center. In another approach, the database is a network of remote databases or servers 114, such as a cloud-based network, that stores the time-series data. In another approach, a combination of a local database 112 and remote databases 114 is used.

A user may query the time-series data stored in the data center 110 via a terminal 116. The terminal 116 is a device sufficiently capable of conveying the query, such as a computer, portable tablet, or smartphone. The query may be directed to an industrial machine or system or a class of industrial machines or systems, and may request, for example, industrial data such as process-related characteristics (e.g., operating temperatures), or production or performance information pertaining to the industrial machines or systems. The query includes a query time range having a beginning time and an end time. For example, a query may request operating temperatures of an industrial machine acquired every hour over a two month period.

As discussed in greater detail elsewhere herein, the data center 110 receives the query and obtains the requested information. In addition, the data center 110 calculates at least one value within the query time range using data obtained outside of the query time range.

The acquired and calculated results are transmitted to the user, and may be presented on a display device 118. The display device 118 may be the same device that transmitted the initial query (e.g., terminal 116), or may be a separate device.

With reference now to FIG. 2, an apparatus 200 (such as data center 110 of FIG. 1) includes a memory 202 and a processor 204 operatively coupled to the memory 202. The memory 202 is capable of storing time-series data records. As used herein, a “time-series data record” is a data structure that includes a data value corresponding to one or more characteristics of an industrial machine or system. The data values may be recorded at sensors associated with the industrial machine or system (e.g., sensors 104a, 104b, 104c, 104d of FIG. 1). The data values stored in the “time-series data record” data structure also include associated times at which the respective data values were recorded.

In one approach, the memory 202 is incorporated within, or physically coupled to, the apparatus 200. In another approach (not shown), the memory 202 is located in a location geographically remote from the operating site apparatus 200, or on a cloud-based network of remote computing devices.

The apparatus 200 further includes an interface 206 that has an input 208 and an output 210. The input 208 is capable of receiving a query for industrial data pertaining to an industrial machine or system. As discussed, the industrial data may be, for example, process-related characteristics or production or performance information pertaining to an industrial machine or system. The query also includes a query time range having a beginning time and an end time. As will be discussed, the query further includes one or two extended interval ranges abutting the query time range.

In response to the input 208 receiving the query, the processor 204 obtains data from the memory 202. The obtained data includes industrial time-series data corresponding to the query, and more particularly, within the query time range. For example, where a query requests operating temperatures of an industrial machine over a defined two month period, the corresponding known data collection includes operating temperatures collected from the industrial machine within the two month query time range.

In many instances, however, industrial data within the requested query time range is not available. This is particularly an issue when the industrial data is associated with the beginning time and/or the end time of the query time range defined by a user. This may be due to beginning time and/or end time corresponding to a time interval at which the industrial machine was not scheduled to capture industrial data. This may also be due to sensor errors at the machine, network connections errors, data compression, or other data loss events.

As discussed in greater detail elsewhere herein, when requested industrial data is not available for a given time period, the processor 204 is configured to calculate an unknown value having an associated time within the query time range based on at least in part on a known value within the query time range and a known value within the extended interval range.

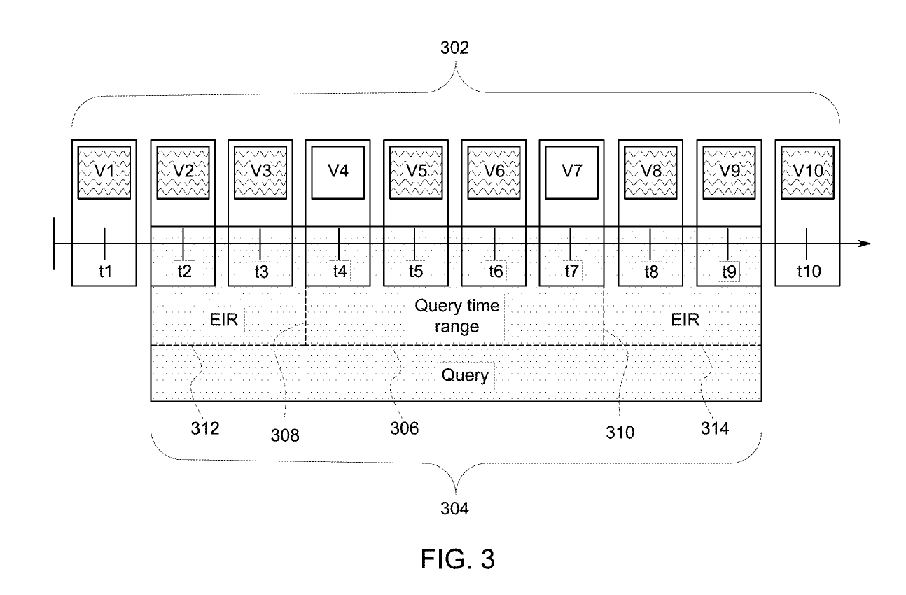

Referring now to FIG. 3, a series of time-series data records 302 may be stored in a memory (e.g., memory 202 of FIG. 2). As discussed, a “time-series data record” is a data structure that includes a data value corresponding to one or more characteristics of an industrial machine or system. The individual time-series data records include a data value (indicated by v₁₋₉). Each data value is associated with a time (indicated by t₁₋₉) corresponding to the time at which the data value was captured. The associated time may be a time period (e.g., a given day), or may be a particular time (e.g. an exact time of a given day). These records 302 are examples. It will be understood that other data structures having values corresponding to characteristics of an industrial machine or system are possible.

In one example, a sensor associated with a wind turbine detects rotation speed for the turbine blades. The rotation speed data is recorded over one minute intervals every five minutes. Data values (e.g., v₁₋₉) representing an average rotation speed for each five minute interval are stored as time-series data records 302 in a memory device (e.g., memory 202). An associated time (e.g., t₁₋₉) corresponding to the five minute time intervals at which each data value was recorded is also stored as part of each time-series data record 302.

A user query 304 for industrial data pertaining to an industrial machine or system includes a query time range 306. The query time range 306 is defined by a beginning time 308 and an end time 310. The beginning time 308 and end time 310 are preferably user-provided values (though the query time range 306 may also be automatically populated). For example, through the query 304, the user may request information pertaining to rotation speed data of the turbine blade from beginning time 308 t₄ and ending at end time 310 t₇.

The query 304 further includes one or two extended interval ranges (EIR) 312, 314 abutting the query time range 306. An EIR is immediately adjacent in time the query time range 306. An EIR is preferably defined by an EIR value that defines a time period extending before the beginning time 308 and/or after the end time 310 of the query time range 304 relative to the query time range 306. In one approach, the EIR value is a user-input value provided along with the query 304. For example, a user may define an EIR of “10 minutes.” In another approach, the EIR value is automatically assigned to the query, for example, as a function of the query time range 306 or the target industrial machine or system.

In the approach shown in FIG. 3, time-series data records 302 corresponding to t₅ and t₆ are stored in the memory. For example, t₅ may have an associated data value v₅ equal to 14 revolutions per minute, and t₆ may have an associated data value v₆ equal to 15 revolutions per minute. However, time-series data records 302 corresponding to t₄ and t₇ are not available in the memory. This may be, for example, because the corresponding wind turbine was not scheduled to capture RPM data at times t₄ and t₇.

In order to provide a user with unknown data values corresponding to a time-series data record within the query data range 306, data values within both the query range 306 and an EIR are obtained. In the example of FIG. 3, a known data value (e.g, v₅) from within the query time range 306 is obtained. A known data value (e.g, v₃) from within the EIR 312 is also obtained. In a preferred approach, when multiple data values fall within the EIR (e.g., v₂ and v₃ of EIR 312), the data value having a time-stamp closest-in-time to the beginning time 308 or the end time of the query time range 310 is selected for calculation of the unknown data value. The closest-in-time data values typically are more relevant to the query time range 306 than further-in-time data values within the EIR. By obtaining only the closest-in-time data values and not other data values, system resources are significantly conserved, and inefficiencies in processing less relevant or unnecessary data are reduced.

An unknown data value v₄ corresponding to t₄ is then calculated based at least in part on known data values v₃ and v₅. The unknown data value v₄ is calculated at a processor, such as the processor 204 of FIG. 2. For example, where the data value v₃ has a time-stamp earlier in time than the beginning time 308, the processor 204 uses the data value v₃ and the earliest-in-time data value within the query range 306, i.e., v₅, to interpolate unknown data value v₄. In one example, the interpolation is an average of one or more data values. In other examples, the interpolation is a curve fitting or regression analysis. In another example, the calculation is performed according to an algorithm. This calculated data generally corresponds to a theoretical data value associated with the beginning time 308 of the query time range 306. For example, known data values v₃ (12 RPMs) and v₅ (14 RPMs) may be averaged to calculate unknown data value v₄ corresponding to t₄ as 13 RPMs. It will be appreciated that these interpolation approaches are examples only and that others may be used.

In some approaches, the processor 204 is configured to calculate unknown data values corresponding to both the beginning time 308 and the end time 310 using first and second data values obtained from EIRs 312, 314, respectively. For example, a first data value v₃ in EIR 312 has a time-stamp t₃ earlier in time than the beginning time t₄ of the query time range 306, and a second data value v₈ in EIR 314 has a time-stamp t₈ later in time than the end time t₇. In this example, the processor 204 uses the first data value v₃ and the earliest-in-time known data value v₅ of the query time range 306 to calculate a first calculated data value v₄. The processor 204 uses the second data value v₈ and the latest-in-time known data value v₆ of the query time range 306 to calculate a second calculated data value v₇. The first calculated data value v₄ generally corresponds to a theoretical data value associated with the beginning time t₄ of the query time range 306, and the second calculated data value v₇ generally corresponds to a theoretical data value associated with the end time t₇ of the query time range 306.

The processor 204 is configured to provide a query response, for example, via the output 210 of the interface 206. The query response includes the obtained known data values and at least one calculated unknown data value. The query response may be, for example, an output file that includes a list of time-series data information. The query response may also include a visual representation of the time-series data information. A user may then analyze the query response and make predication or implement results based on the analysis.

In another approach, the processor 204 is configured to calculate unknown data values within the query time range using only data values from one or both extended interval ranges. In one example of such an approach, a first data value (e.g., v₃) of a first record is obtained. The first data value has an associated time within an extended interval range (e.g., EIR 312) and earlier in time than the query start time 308. A second record (e.g., v₈) is also obtained. The second data value has an associated time within an extended interval range (e.g., EIR 314) and later in time than the query end time 310. In this example, the processor 204 uses the first and second data values to calculate one or more values for records within the query time range 306.

In another example, the processor 204 is configured to use one or more data values from a single extended interval range to calculate unknown data values within the query range. In one aspect, a first data value (e.g., v₃) of a first record is obtained. The first data value has an associated time within an extended interval range (e.g., EIR 312) and earlier in time than the query start time 308. In this aspect, the processor 204 uses the first data value to calculate one or more values for records within the query time range 306. In another aspect, a first data value (e.g., v₂) of a first record and a second data value (e.g., v₃) of a second record are obtained. The first and second data values each have associated times within an extended interval range (e.g., EIR 312) and earlier in time than the query start time 308. In this aspect, the processor 204 uses the first and second data values to calculate one or more values for records within the query time range 306.

In an optional approach, the apparatus 200 further includes a display device 212 such as a monitor. The display device 212 may display, for example, information pertaining to the query, the target machine or system, or to the query response.

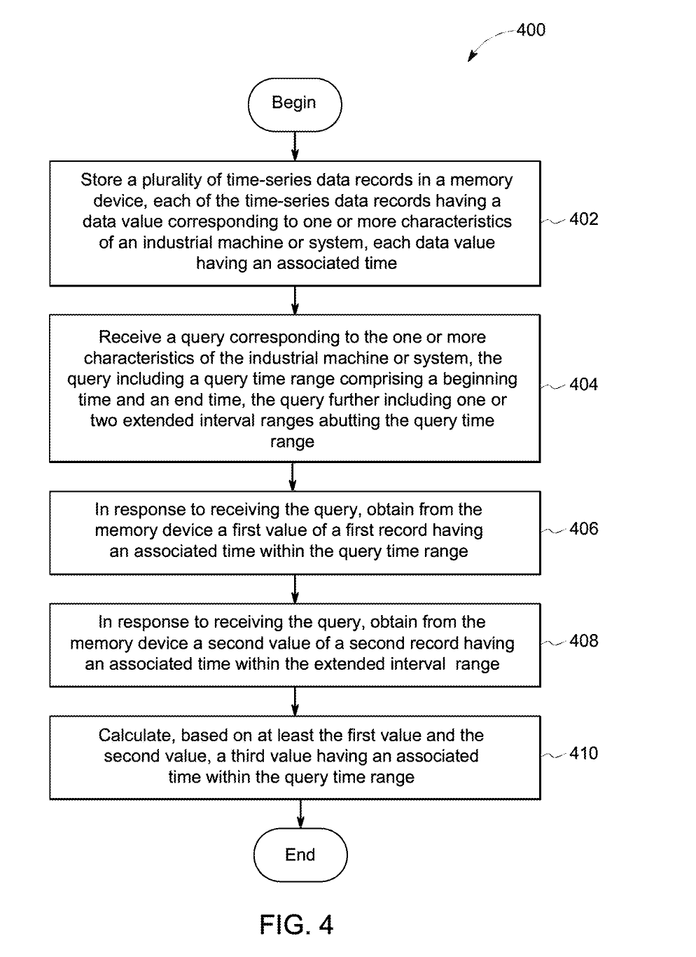

Turning now to FIG. 4, a method 400 includes storing 402 a plurality of time-series data records in a memory device. Each of the time-series data records has a data value corresponding to one or more characteristics of an industrial machine or system. Each data value also has an associated time corresponding to the time the data value was obtained at the industrial machine or system.

The method 400 also includes receiving 404 a query corresponding to the one or more characteristics of the industrial machine or system. The query includes a query time range comprising a beginning time and an end time. The query further includes one or two extended interval ranges abutting the query time range.

The method 400 also includes, in response to receiving the query, obtaining 406 from the memory device a first value of a first record having an associated time within the query time range. The method 400 also includes, in response to receiving the query, obtaining 408 from the memory device a second value of a second record having an associated time within the extended interval range.

The method 400 also includes calculating 410, based on at least the first value and the second value, a third value having an associated time within the query time range.

In some approaches, the method 400 includes providing a query response comprising at least the first value and the third value.

The method 400 may further include, in response to receiving the query, obtaining from the memory device a fourth value of a fourth record having an associated time within the query time range. Also in response to receiving the query, the method 400 may include obtaining from the memory device a fifth value of a fifth record having an associated time within a second extended interval range. Based on at least the fourth value and the fifth value, a sixth value having an associated time within the query time range is calculated.

In some aspects, the method 400 further includes providing a query response comprising at least the first value, the third value, the fourth value, and the sixth value.

The above approaches provide for efficient collection, archival, and distribution of large volumes of data in real time. More specifically, these approaches provide data at beginning and end times of a query time range where such values may not otherwise be available. These approaches may improve visibility and provide context to raw data. This additional data may provide for more informed decisions. Use of this information may also improve data management, process optimization, remote monitoring, predictive diagnostics, asset health, operational excellence, quality management, and compliance within industrial settings.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method comprising:
storing a plurality of time-series data records in a memory device, each of the time-series data records having a data value corresponding to one or more characteristics of an industrial machine or system, each data value having an associated time;
receiving a query corresponding to the one or more characteristics of the industrial machine or system, the query including a query time range comprising a beginning time and an end time, the query further including one or two extended interval ranges abutting the query time range;
in response to receiving the query, obtaining from the memory device a first value of a first record having an associated time within the query time range;
in response to receiving the query, obtaining from the memory device a second value of a second record having an associated time within the extended interval range; and
calculating, based on at least the first value and the second value, a third value having an associated time within the query time range.

2. The method of claim 1, further comprising:
providing a query response comprising at least the first value and the third value.

3. The method of claim 1, wherein the extended interval range is defined by an extended interval value and at least one of the beginning time and the end time.

4. The method of claim 1, wherein the time associated with the second value of the second record is earlier in time than the beginning time.

5. The method of claim 1, wherein the time associated with the second value of the second record is later in time than the end time.

6. The method of claim 1, further comprising:
in response to receiving the query, obtaining from the memory device a fourth value of a fourth record having an associated time within the query time range;
in response to receiving the query, obtaining from the memory device a fifth value of a fifth record having an associated time within a second extended interval range; and
calculating, based on at least the fourth value and the fifth value, a sixth value having an associated time within the query time range.

7. The method of claim 6, further comprising:
providing a query response comprising at least the first value, the third value, the fourth value, and the sixth value.

8. An apparatus, the apparatus comprising:
a memory configured to store a plurality of time-series data records, each of the time-series data records having a data value corresponding to one or more characteristics of an industrial machine or system, each data value having an associated time;
an interface comprising an input and an output, the input configured to receive a query corresponding to the one or more characteristics of the industrial machine or system, the query including a query time range comprising a beginning time and an end time, the query further including one or two extended interval ranges abutting the query time range;
a processor coupled to the interface, the processor configured to:
in response to receiving the query, obtain from the memory a first value of a first record having an associated time within the query time range;
in response to receiving the query, obtain from the memory device a second value of a second record having an associated time within the extended interval range; and
calculate, based on at least the first value and the second value, a third value having an associated time within the query time range.

9. The apparatus of claim 8, wherein the processor is configured to provide, via an output, a query response comprising at least the first value and the third value.

10. The apparatus of claim 8, wherein the extended interval range is defined by an extended interval value and at least one of the beginning time and the end time.

11. The apparatus of claim 8, wherein the time associated with the second value of the second record is earlier in time than the beginning time.

12. The apparatus of claim 8, wherein the time associated with the second value of the second record is later in time than the end time.

13. The apparatus of claim 8, wherein the processor is further configured to:
in response to receiving the query, obtain from the memory a fourth value of a fourth record having an associated time within the query time range;
in response to receiving the query, obtain from the memory a fifth value of a fifth record having an associated time within a second extended interval range; and
calculate, based on at least the fourth value and the fifth value, a sixth value having an associated time within the query time range.

14. The apparatus of claim 13, wherein the processor is further configured to provide a query response comprising at least the first value, the third value, the fourth value, and the sixth value.
